(19) United States
(12) Patent Application Publication
(10) Pub. No.: US 2026/0369772 A1
(43) Pub. Date: Nov. 19, 2026

(54) Electric Energy Storage Device, and Motor Vehicle

(71) Applicant: Bayerische Motoren Werke Aktiengesellschaft, Muenchen (DE)

(72) Inventor: Julian PATSCHEIDER, Muenchen (DE)

(21) Appl. No.: 19/124,329

(22) PCT Filed: Oct. 23, 2023
(86) PCT No.: PCT/EP2023/079462

§ 371 Date: Apr. 25, 2025

(30) Foreign Application Priority Data
Oct. 27, 2022 (DE) 10 2022 128 444.1

(51) Int. Cl. H01M 50/242

(52) U.S. Cl. CPC H01M 50/242

(57) ABSTRACT

The present disclosure relates to an electric energy storage device comprising one or more energy storage cells, a delimiting plate, one or more protective elements, and at least one support element, wherein a counterforce is generated when a force is exerted on the delimiting plate. The present disclosure also relates to an associated motor vehicle.

### BACKGROUND AND SUMMARY

The invention relates to an electrical energy-storage device and also to a motor vehicle having such an electrical energy-storage device.

Electrical energy-storage devices are typically used in order to store electric current in motor vehicles or in other mobile or stationary devices. For instance, such an electrical energy-storage device can be used for the purpose of storing electricity in a battery electric vehicle. It has become evident that, depending upon their installation position, electrical energy-storage devices of such a type are variably affected by accident events.

It is therefore an object of the invention to make available an electrical energy-storage device that is better protected-for instance, in the case of certain impact events-in comparison with known designs. It is furthermore an object of the invention to make available a motor vehicle having such an electrical energy-storage device. In accordance with the invention, this is achieved by virtue of an electrical energy-storage device and also a motor vehicle according to the respective main claims. Advantageous configurations are, for instance, claimed in the dependent claims. By explicit reference thereto, the content of the claims is made the content of the description.

The invention relates to an electrical energy-storage device. The electrical energy-storage device exhibits one or more energy-storage cells. The energy-storage device exhibits a boundary plate. The energy-storage device further exhibits one or more protective elements, each protective element entirely or partly surrounding at least one associated energy-storage cell, and exhibiting at least one contact surface which faces toward the boundary plate. The electrical energy-storage device further exhibits at least one supporting element. At least one protective element has been arranged adjoining a supporting element, so that in the event of a buckling of the boundary plate on the associated energy-storage cell the boundary plate presses the protective element on a contact surface against the supporting element.

By means of such an electrical energy-storage device, the reaction of the electrical energy-storage device to an indenting of the boundary plate can be improved. The protective element can generate a force counteracting an indenting and can thereby stabilize the boundary plate. A further deformation is thereby prevented, as a result of which damage to the energy-storage cells can be avoided or lessened. The resistance of an electrical energy-storage device to impact events—for instance in the case of an accident of a motor vehicle—can thereby be increased considerably.

The energy-storage cells may be, in particular, electrical energy-storage cells. The energy-storage cells can, in particular, be charged and discharged. A boundary plate may, in particular, take the form of a flat plate. The boundary plate may, however, also be curved. The boundary plate may, in particular, constitute an outer boundary of the electrical energy-storage device. The boundary plate may, for instance, take the form of a housing of the energy-storage device or a part of such a housing. The protective elements serve, in particular, to protect the energy-storage cells. One protective element may have been provided, or several protective elements may have been provided. By virtue of the fact that a protective element entirely or partly surrounds an energy-storage cell, the energy-storage cell can be protected by the protective element. An indenting of the energy-storage cell is made more difficult in this case by virtue of the fact that the protective element would also have to be indented and/or destroyed. As a result, the protective element protects the energy-storage cell against indenting or other damage. For instance, a protective element may surround an energy-storage cell on three sides, viewed in cross-section. This can be done, in particular, in a plane at right angles to a longitudinal extent of the energy-storage cell. The contact surface points, in particular, toward the boundary plate. This may mean that the contact surface bears against the boundary plate; it may, however, also be spaced therefrom. For instance, the contact surface may be oriented parallel to the boundary plate. The supporting element may serve, in particular, to constitute a counter-bearing in the case of a pressure on the contact surface, in order to limit the movement of the protective element. As a result, the protective action can be achieved or improved. If the contact surface directly adjoins the boundary plate, in particular any buckling of the boundary plate in the direction toward the protective element may result in a movement of the protective element. If the contact surface is spaced from the boundary plate, in particular a certain buckling of the boundary plate toward the protective element can be tolerated before the contact surface is then contacted and results in a movement of the protective element. Depending upon the embodiment, instead of a movement of the protective element merely an application of force may have been provided for.

According to one embodiment, one, some or all of the supporting elements for, in each instance, a protective element take the form of pivot bearings, so that in the event of pressure on a contact surface by virtue of the boundary plate another contact surface of the protective element, or another portion of the contact surface, presses the boundary plate away from the associated energy-storage cell. As a result, a direct counteracting force can be exerted on the boundary plate, so that any deformation is counteracted. To the extent that a pressure on the boundary plate has been applied over such a wide area that an application of force occurs both on the contact surface and on the other portion of the contact surface, or on the other contact surface, the force acting on the boundary plate can be directed toward the pivot bearing, and consequently a supporting effect over a wider area can be achieved. As a result, the energy-storage cells can be advantageously protected.

According to one embodiment, the electrical energy-storage device exhibits a further boundary plate, the energy-storage cells having been arranged, in particular, between the boundary plate and the further boundary plate. By this means, a boundary can be achieved on two sides—for instance, on two lateral surfaces—of the energy-storage device. The protective action can, for instance, be realized on both sides.

According to one embodiment, one, some or all of the supporting elements take(s) the form of a respective further protective element, each further protective element entirely or partly surrounding, in particular, the energy-storage cell or the energy-storage cells that is/are associated with the protective element for which the further protective element is a supporting element. As a result, supporting elements may take the form of protective elements and may enable a protective action on an opposite side. Expressed otherwise, the further protective elements may have been designed in such a way that they exercise the function of a protective element and of a supporting element simultaneously. In particular, by virtue of such an embodiment an advantageous bilateral protection of energy-storage cells can be achieved. With respect to the design of the further protective elements, let reference be made to the remarks given herein relating to protective elements, which can be applied correspondingly.

In particular, one, some or all of the further protective elements may each exhibit at least one further contact surface which faces toward the further boundary plate. With respect to the further contact surfaces, let reference be made to the remarks relating to the contact surfaces, which are applicable correspondingly.

The further protective elements may, in particular, have been arranged and/or formed in mirror-symmetric manner relative to the protective elements. In particular, the further protective elements may have been formed in mirror-symmetric manner with respect to a plane. The plane, which may also be regarded as a mirror plane, may, in particular, be arranged between the protective elements and the further protective elements.

According to one embodiment, the protective elements and the further protective elements may also have been formed, at least partly, in one piece.

According to a respective embodiment, one, some or all of the protective elements have been designed in such a manner that they each exhibit only one contact surface, and/or one, some or all of the further protective elements have been designed in such a manner that they each exhibit only one contact surface. Through the provision of only one contact surface on the protective element, a complete planar abutment or a uniform spacing from the boundary plate and/or from the further boundary plate can, for instance, be provided. If force is to be applied at several points, the contact surface may, for instance, be subdivided into several portions, in which case these portions may take the form of, for instance, recognizably separate portions, for instance by provision of notches in between them, or may even be delimited from one another purely by reason of their functionality, or by imaginary lines.

According to a respective embodiment, one, some or all of the protective elements each exhibit a first contact surface and a second contact surface, separate from the first. According to a respective embodiment, one, some or all of the further protective elements each exhibit a first further contact surface and a second further contact surface, separate from the first. The respective contact surface and the respective further contact surface may, for instance, have been separated from one another structurally, for instance by virtue of the fact that they have been formed on different projections of the respective protective element or further protective element.

According to a respective embodiment, there is provision that one protective element, some of the protective elements or all of the protective elements each circumferentially surround precisely one associated energy-storage cell. There may also be provision that one further protective element, some of the further protective elements or all of the further protective elements each circumferentially surround precisely one associated energy-storage cell. As a result, each protective element or further protective element is associated with precisely one energy-storage cell and is primarily responsible for the protection thereof. In principle, however, it is also possible that, for instance, a protective element or further protective element surrounds several energy-storage cells, and/or that there are energy-storage cells that are not surrounded by a protective element. Surrounding an energy-storage cell by a protective element may mean, in particular, that the protective element surrounds the respective energy-storage cell on several sides, in particular on three sides in cross-section. For instance, an energy-storage cell may have been surrounded by a protective element on three sides, and by a boundary plate on a further side.

According to one embodiment, there may be provision that one contact surface, some of the contact surfaces or all of the contact surfaces bear(s) against the boundary surface, and/or one further contact surface, some of the further contact surfaces or all of the further contact surfaces bear(s) against the further boundary plate. As a result, a direct application of force can be achieved even in the case of a slight buckling of the boundary plate or in the case of a correspondingly small force on the boundary plate.

The boundary plate may preferably cover all the energy-storage cells. Similarly, the further boundary plate may preferably cover all the energy-storage cells. As a result, a bilateral enclosure of the energy-storage cells can be achieved. Alternatively, however, there may also be provision that the boundary plate and/or the further boundary plate cover(s) only some of the energy-storage cells.

The boundary plate may, in particular, be spaced from the energy-storage cells, and/or the further boundary plate may, in particular, be spaced from the energy-storage cells. As a result, it can, in particular, be ensured that a certain indenting of the boundary plate or of the further boundary plate does not yet result in a contact with an energy-storage cell, and consequently damage is advantageously avoided. Indenting can, in particular, be avoided or limited by the measures described herein. Damage to energy-storage cells can be effectively prevented by this means.

In particular, one, some or all of the energy-storage cells may take the form of round cells. The energy-storage cells may, however, alternatively have, for instance, a different cross-section such as, for instance, a square or rectangular cross-section.

According to one embodiment, one or more cooling ducts has/have been formed, in each instance, in one, some or all of the protective elements and/or on one, some or all of the further protective elements. By means of such cooling ducts, the protective elements may also find application for a cooling action in addition to their protective function. Cooling liquid or a different cooling medium can be passed through the cooling ducts, so that the energy-storage cells can be cooled. This can avoid an overheating of the energy-storage cells, for instance in the course of charging.

The cooling ducts may, in particular, assume arbitrary topologies within the protective elements. The cooling ducts may, for instance, have been arranged tangentially along round cells and/or in meandering manner on the outer surfaces of round cells.

The invention further relates to a motor vehicle having an electrical energy-storage device as described herein. With respect to the electrical energy-storage device, all the embodiments and variants described herein may be drawn upon.

In particular, by virtue of the measures described herein a redirection of force can be achieved, so that a potential intrusion can be reduced. The elements described herein can also enable handling for assembly; they can also enable a definition of the spacing in a cell array.

A cell intrusion may, in particular, be slighter than without the measures described herein, because a counteracting force is generated.

### BRIEF DESCRIPTION OF THE DRAWINGS

Examples of embodiments of the invention will be described below with reference to the appended drawing.

FIG. 1: shows a detail from an electrical energy-storage device,

FIG. 2: shows an electrical energy-storage device in a sectional view,

FIG. 3: shows a part of an electrical energy-storage device in a plan view,

FIG. 4: shows an electrical energy-storage device in a sectional view according to a further embodiment, and

FIG. 5: shows a part of the energy-storage device of FIG. 4 in a plan view.

### DETAILED DESCRIPTION OF THE DRAWINGS

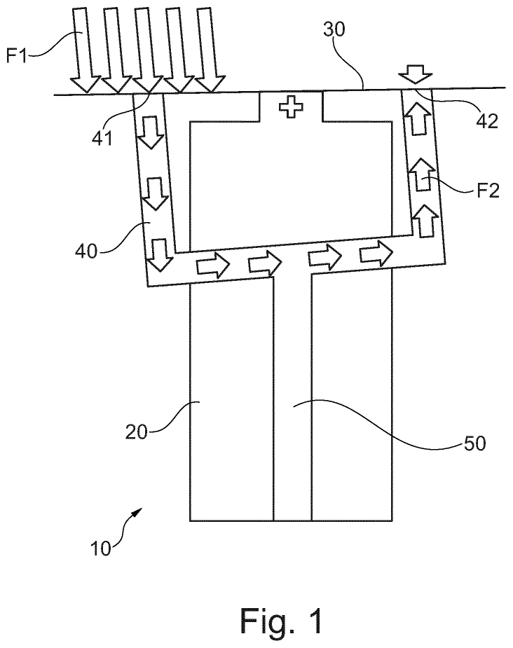

FIG. 1 shows a detail from an electrical energy-storage device 10. The electrical energy-storage device 10 exhibits several energy-storage cells 20, one of which is shown in FIG. 1. The electrical energy-storage cell 20 takes the form of a round cell. The electrical energy-storage cell is able to store electric current, for instance for the purpose of supplying current to an electrically-driven vehicle.

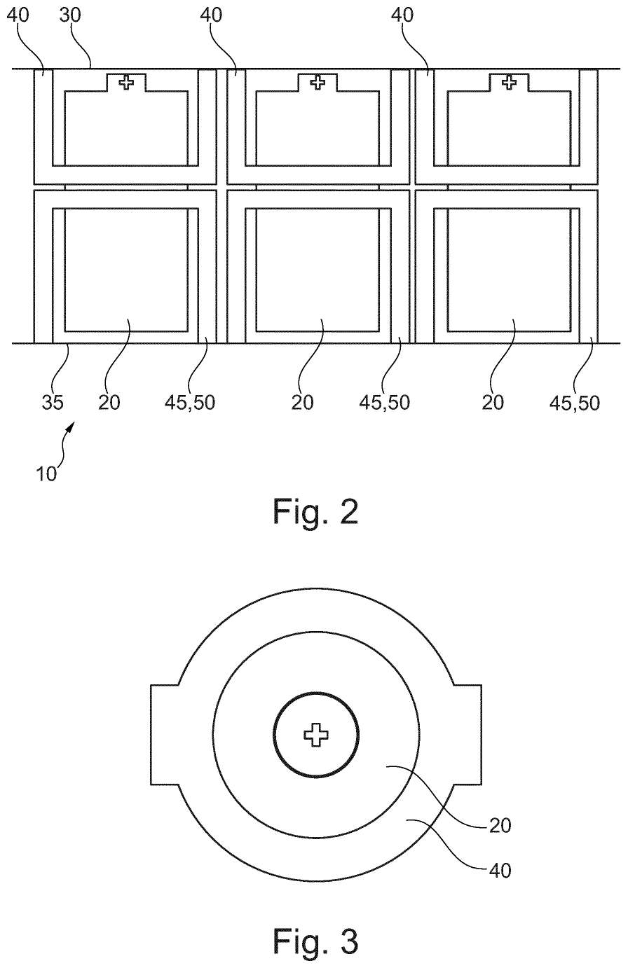

The electrical energy-storage device 10 exhibits a boundary plate 30. This boundary plate covers all the energy-storage cells 20 on one side. This can be seen in FIG. 2, for instance.

The electrical energy-storage device 10 exhibits a protective element 40 which is associated with the energy-storage cell 20. The protective element 40 in the present case is U-shaped in cross-section. The protective element exhibits a first contact surface 41 and a second contact surface 42. The contact surfaces 41, 42 bear against the boundary plate 30. Opposite this, the protective element 40 is supported on a supporting element 50. The supporting element 50 in the present case takes the form of a rod which, for instance, may have been supported on an opposing plate or on a body shell.

If a first force F1, which is an external force and which may, for instance, stem from an impact event, is now exerted on the boundary plate 30 in the region of the first contact surface 41, this force F1 is introduced into the protective element 40. This is represented by arrows in the protective element 40. In this case, the supporting element 50 acts as a pivot bearing, so that the force is redirected to the second contact surface 42 and presses against the boundary plate 30 on the second contact surface 42. This generates a counteracting force F2 which stabilizes the boundary plate 30 and prevents an excessive deformation of the boundary plate 30, even against a possible external force opposed by the counteracting force F2.

FIG. 2 shows an embodiment of an electrical energy-storage device 10 with three energy-storage cells 20. These cells are oriented parallel to one another. With respect to the boundary plate 30 and the protective elements 40, reference is made to the description of FIG. 1.

In contrast to the embodiment shown in FIG. 1, however, the supporting elements 50 take the form not of bars but rather of a respective further protective element 45. The respective further protective element 45 also surrounds the respectively associated energy-storage cell 20 and is, as shown, U-shaped in cross-section. The further protective elements 45 bear, with respective further contact surfaces not designated separately, against a further boundary plate 35 which delimits the electrical energy-storage device 10 parallel to the boundary plate 30 and opposite the boundary plate 30.

As already mentioned, the further protective elements 45 serve as supporting elements 50 for, in each instance, a protective element 40. A protective element 40 and a further protective element 45 surround, in each instance, an energy-storage cell 20. In the case where an external force is exerted on one of the boundary plates 30, 35 and results in a deformation of the boundary plate 30, 35, the corresponding force is introduced into one or more protective elements 40 or further protective elements 45, which is supported on a further protective element 45 or on a protective element 40. As a result, a transmission of force can take place, so that also in this case a counteracting force on the boundary plate 30 and/or on the further boundary plate 35 is generated. By this means, a deformation of the respective boundary plate 30, 35 can be lessened or prevented.

FIG. 3 shows a plan view of an energy-storage cell 20 with a surrounding protective element 40. As shown, the protective element 40 circumferentially surrounds the energy-storage cell 20, so that an all-round protective action is generated. The protective element 40 can, for instance, also be used in order to be gripped by a manipulator such as a robot arm, for instance, so that a simple positioning of the protective element 40 with an energy-storage cell 20 can take place.

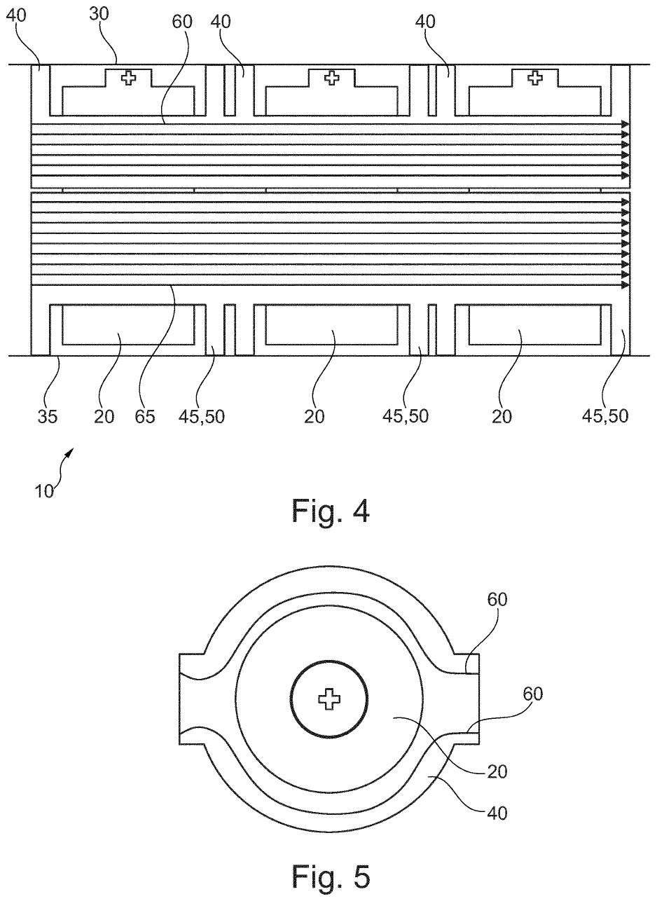

FIGS. 4 and 5 show an electrical energy-storage device substantially corresponding to FIGS. 2 and 3. In contrast, however, the protective elements 40, 45 have been constructed to be thicker higher up; they are partly connected to one another; and they contain cooling ducts 60, 65. These cooling ducts 60, 65 can be used in order to pump through cooling liquid which can be used, for instance, in order to cool the electrical energy-storage device 10. This permits the integration of a cooling functionality into the protective elements 40, 45 which otherwise exercise a protective function. As can be seen in FIG. 5, the cooling ducts 60, 65 may, for instance, be conducted tangentially, at least partly, along a respective circumference of an energy-storage cell 20. This permits direct and efficient cooling.

### LIST OF REFERENCE SYMBOLS

10 electrical energy-storage device
20 energy-storage cell
30 boundary plate
35 further boundary plate
40 protective element
41 first contact surface
42 second contact surface
45 further protective element
50 supporting element
60 cooling duct
65 further cooling duct

1-15. (canceled)

16. An electrical energy-storage device, comprising:
one or more energy-storage cells;
a boundary plate;
one or more protective elements, where each protective element at least partially surrounds at least one associated energy-storage cell, and comprises at least one contact surface which faces toward the boundary plate; and
at least one supporting element;
wherein at least one protective element is arranged adjoining a supporting element such that in the event of a buckling of the boundary plate on the associated energy-storage cell, the boundary plate presses the protective element on a contact surface against the supporting element.

17. The electrical energy-storage device according to claim 16, wherein at least one of the supporting elements for a protective element takes the form of pivot bearings, so that in the event of pressure on a contact surface by the boundary plate another contact surface of the protective element, or another portion of the contact surface, presses the boundary plate away from the associated energy-storage cell.

18. The electrical energy-storage device according to claim 16, comprising a further boundary plate, wherein the energy-storage cells are arranged between the boundary plate and the further boundary plate.

19. The electrical energy-storage device according to claim 18, wherein at least one of the supporting elements takes the form of a respective further protective element, wherein each further protective element at least partially surrounds the energy-storage cell or the energy-storage cells associated with the protective element for which the further protective element is a supporting element.

20. The electrical energy-storage device according to claim 19, wherein at least one of the further protective elements comprise at least one further contact surface which faces toward the further boundary plate.

21. The electrical energy-storage device according to claim 19, wherein the further protective elements have been arranged and formed in mirror-symmetric manner relative to the protective elements.

22. The electrical energy-storage device according to claim 16, wherein:
at least one of the protective elements comprises only one contact surface, and/or
at least one of the further protective elements each exhibit only one contact surface.

23. The electrical energy-storage device according to claim 16, wherein:
at least one of the protective elements comprises a first contact surface and a second contact surface, separate from the first contact surface, and/or
at least one of the further protective elements comprises a first further contact surface and a second further contact surface, separate from the first.

24. The electrical energy-storage device according to claim 16, wherein:
at least one protective element circumferentially surrounds precisely one associated energy-storage cell, and/or
at least one further protective element circumferentially surrounds precisely one associated energy-storage cell.

25. The electrical energy-storage device according to claim 16, wherein:
at least one contact surface bears against the boundary plate; and/or
at least one further contact surface bears against the further boundary plate.

26. The electrical energy-storage device according to claim 16, wherein:
the boundary plate covers all the energy-storage cells; and/or
the further boundary plate covers all the energy-storage cells.

27. The electrical energy-storage device according to claim 16, wherein:
the boundary plate is spaced from the energy-storage cells, and/or
the further boundary plate is spaced from the energy-storage cells.

28. The electrical energy-storage device according to claim 16, wherein at least one of the energy-storage cells takes the form of round cells.

29. The electrical energy-storage device according to claim 16, wherein:
one or more cooling ducts has/have been formed in at least one of the protective elements or in at least one of the further protective elements.

30. A motor vehicle exhibiting an electrical energy-storage device according to claim 16.
